(19) United States
(12) Patent Application Publication
(10) Pub. No.: US 2025/0125826 A1
(43) Pub. Date: Apr. 17, 2025

(54) Communication apparatus

(71) Applicant: REAL TEK SEMICONDUCTOR CORPORATION, HSINCHU (TW)

(72) Inventor: HUNG-YUAN YANG, Hsinchu (TW)

(21) Appl. No.: 18/896,981

(22) Filed: Sep. 26, 2024

(30) Foreign Application Priority Data
Oct. 13, 2023 (TW) 112139092

(51) Int. Cl. H04B 1/04

(52) U.S. Cl. CPC H04B 1/0483; H04B 1/0458; H04B 2001/0408

(57) ABSTRACT

The present disclosure discloses a communication apparatus. A first signal path is electrically coupled to the signal co-processing circuit. A switch electrically couples a second signal path to the signal co-processing circuit under a merged communication state. A first signal amplifying circuit is electrically coupled between the signal co-processing circuit and a first antenna. A first signal transceiver circuit performs communication in a first frequency band with the first antenna through the first signal path, the signal co-processing circuit, the first signal amplifying circuit and the first antenna. A second signal transceiver circuit performs communication in a second frequency band with the first antenna through the second signal path, the signal co-processing circuit, the first signal amplifying circuit and the first antenna.

### BACKGROUND OF THE INVENTION

### 1. Field of the Invention

The present disclosure relates to a communication apparatus.

### 2. Description of Related Art

Along with the development of wireless communication technologies, the demands of data transmission bandwidth of the wireless communication products from the users become higher. Various kinds of wireless communication protocols increase both the transmission bandwidth and the number of uplink and downlink data streams in response to such a trend. For example, Carrier Aggregation (CA) technology of Long Term Evolution (LTE) wireless standard and Multi-Input Multi-Output (MIMO) system of WiFi standard are developed under such a circumstance.

However, additional uplink and downlink data streams make the transceiver circuit consume more power. For a handheld electronic apparatus, the trade-off between the network bandwidth and the power dissipation of the batteries is inevitable.

### SUMMARY OF THE INVENTION

In consideration of the problem of the prior art, an object of the present disclosure is to provide a communication apparatus.

The present invention discloses a communication apparatus that includes a first antenna, a signal co-processing circuit, a first signal amplifying circuit, a first signal path, a second signal path, a switch, a first signal transceiver circuit and a second signal transceiver circuit. The first signal amplifying circuit is electrically coupled between the signal co-processing circuit and the first antenna. The first signal path is electrically coupled to the signal co-processing circuit. The switch is electrically coupling the second signal path to the signal co-processing circuit under a merged communication state. The first signal transceiver circuit is configured to perform communication in a first frequency band through the first signal path, the signal co-processing circuit, the first signal amplifying circuit and the first antenna. The second signal transceiver circuit is configured to perform communication on a second frequency band through the second signal path, the switch, the signal co-processing circuit, the first signal amplifying circuit and the first antenna under the merged communication state.

These and other objectives of the present disclosure will no doubt become obvious to those of ordinary skill in the art after reading the following detailed description of the preferred embodiments that are illustrated in the various figures and drawings.

### BRIEF DESCRIPTION OF THE DRAWINGS

FIG. 1 illustrates a block diagram of a communication apparatus according to an embodiment of the present invention.

FIG. 2 illustrates a block diagram of a communication apparatus according to an embodiment of the present invention.

FIG. 3 illustrates a block diagram of a communication apparatus according to an embodiment of the present invention.

FIG. 4 illustrates a block diagram of a communication apparatus according to an embodiment of the present invention.

FIG. 5 illustrates a block diagram of a communication apparatus according to an embodiment of the present invention.

FIG. 6 illustrates a block diagram of a communication apparatus according to an embodiment of the present invention.

### DETAILED DESCRIPTION OF THE PREFERRED EMBODIMENTS

An aspect of the present invention is to provide a communication apparatus to dispose a signal amplifying circuit in front of an antenna so as to perform signal switching and merging at a small-signal level first and perform signal amplifying subsequently in a signal transmission process to decrease the power loss. Further, the communication apparatus performs signal amplifying first and performs signal switching and splitting subsequently in a signal receiving process such that a lowest sensitivity of the signal receiving is not affected.

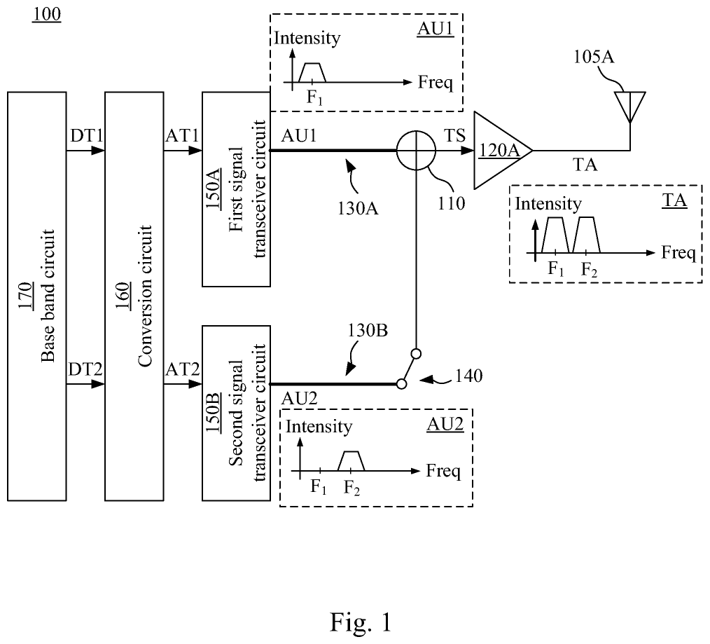

Reference is now made to FIG. 1. FIG. 1 illustrates a block diagram of a communication apparatus 100 according to an embodiment of the present invention. The communication apparatus 100 includes a first antenna 105A, a signal co-processing circuit 110, a first signal amplifying circuit 120A, a first signal path 130A, a second signal path 130B, a switch 140, a first signal transceiver circuit 150A, a second signal transceiver circuit 150B, a conversion circuit 160 and a base band circuit 170.

The connection relation of the components in the communication apparatus 100 is first described in the following paragraphs.

The first signal amplifying circuit 120A is electrically coupled between the first antenna 105A and the signal co-processing circuit 110. In the present embodiment, the first signal amplifying circuit 120A is a power amplifier (PA), and the signal co-processing circuit 110 is a power combiner.

In the present embodiment, the first signal path 130A is a first signal transmission path and is electrically coupled to the signal co-processing circuit 110. In an embodiment, the first signal path 130A may not include any circuit component or may include at least one circuit component that does not affect the function of the communication apparatus 100. The present invention is not limited thereto.

In the present embodiment, the second signal path 130B is a second signal transmission path. In an embodiment, the second signal path 130B may not include any circuit component or may include at least one circuit component that does not affect the function of the communication apparatus 100. The present invention is not limited thereto.

In the present embodiment, neither of the first signal path 130A and the second signal path 130B includes a power amplifying circuit. That is, the first signal path 130A and the second signal path 130B do not have the function of power amplifying on the signals.

The switch 140 is configured to operate under either a merged communication state or a non-merged communication state. In the present embodiment, the switch 140 electrically couples the second signal path 130B and the signal co-processing circuit 110 under the merged communication state. The switch 140 makes the second signal path 130B floating under the non-merged communication state.

The first signal transceiver circuit 150A is configured to perform communication in a first frequency band with another communication apparatus (not illustrated in the figure) through the first signal path 130A, the signal co-processing circuit 110, the first signal amplifying circuit 120A and the first antenna 105A. In the present embodiment, the first signal transceiver circuit 150A performs signal transmission by using a transmitting circuit (TX, not illustrated in the figure) therein through the components described above.

The second signal transceiver circuit 150B, under the merged communication state, is configured to perform communication in a second frequency band with another communication apparatus (not illustrated in the figure) through the second signal path 130B, the switch 140, the signal co-processing circuit 110, the first signal amplifying circuit 120A and the first antenna 105A. In the present embodiment, the second signal transceiver circuit 150B performs signal transmission by using a transmitting circuit (not illustrated in the figure) therein through the components described above.

The base band circuit 170 is electrically coupled to the first signal transceiver circuit 150A and the second signal transceiver circuit 150B through the conversion circuit 160.

The operation of the components in the communication apparatus 100 is subsequently described in the following paragraphs.

In operation, the base band circuit 170 provides a first digital signal DT1 to the conversion circuit 160 to perform digital-to-analog conversion thereon to generate a first analog signal AT1. The first analog signal AT1 is further transmitted by the conversion circuit 160 to the first signal transceiver circuit 150A. The first signal transceiver circuit 150A is configured to perform frequency up-conversion or other signal processing on the first analog signal AT1 to generate a first analog signal AU1 and transmit the first analog signal AU1 corresponding to the first frequency band to the signal co-processing circuit 110 through the first signal path 130A that is the first signal transmission path.

On the other hand, the base band circuit 170 provides a second digital signal DT2 to the conversion circuit 160 to perform digital-to-analog conversion thereon to generate a second analog signal AT2. The second analog signal AT2 is further transmitted by the conversion circuit 160 to the second signal transceiver circuit 150B. The second signal transceiver circuit 150B is configured to perform frequency up-conversion or other signal processing on the second analog signal AT2 to generate a second analog signal AU2 and transmit the second analog signal AU2 corresponding to the second frequency band to the signal co-processing circuit 110 through the second signal path 130B that is the second signal transmission path.

In an embodiment, the conversion circuit 160 described above may perform digital-to-analog conversion by using a digital-to-analog conversion circuit (not illustrated in the figure) therein.

In an embodiment, both of the first signal transceiver circuit 150A and the second signal transceiver circuit 150B do not perform any power amplifying on the first analog signal AT1 and the second analog signal AT2.

The signal co-processing circuit 110, implemented by a power combiner, merges first analog signal AU1 and the second analog signal AU2 to generate a transmission signal TS. Since the first analog signal AU1 belongs to the first frequency band and the second analog signal AU2 belongs to the second frequency band, the first analog signal AU1 and the second analog signal AU2 do not interfere with each other in the merged transmission signal TS.

The first signal amplifying circuit 120A further performs signal amplifying on the transmission signal TS to generate a transmission signal TA such that the first antenna 105A performs signal transmission on the transmission signal TA that is amplified.

In FIG. 1, a frequency spectrum diagram is shown at a side of each of the labels of the first analog signal AU1, the second analog signal AU2 and the transmission signal TA, in which an X-axis stands for frequency (abbreviated as Freq) and a Y-axis stands for intensity. The first analog signal AU1 has a central frequency F1 and the second analog signal AU2 has a central frequency F2. In an embodiment, each of the first frequency band and the second frequency band has a bandwidth of 80 MHz. The first frequency band and the second frequency band together form an equivalent bandwidth of 160 MHz. As a result, the frequency F2 and the frequency F1 are distanced from each other for 80 MHz.

In an embodiment, since the switch 140 makes the second signal path 130B floating under the non-merged communication state, the second signal transceiver circuit 150B does not perform communication when the switch 140 operates under the non-merged communication state.

In some approaches, each of different signal transceiver circuits is equipped with a unique power amplifying circuit to perform signal amplifying first and perform signal merging and signal transmission subsequently. At first, the power amplifying circuit consumes more power to convert the small signal to a large signal. Secondly, in order to satisfy the requirement of the frequency spectrum regulation, an additional filter is needed to suppress the out-of-band emissions after the process of the power amplifying circuit such that the power amplifying circuit needs to provide more power to compensate the insertion loss caused by the additional filter.

Furthermore, taking the requirement of linearity and the characteristic of the material of the transmitting circuit into consideration, the highest power conversion efficiency of the power amplifying circuit is roughly 35%. In other words, the power amplifying circuit needs to consume a direct current power that is three times of the radio frequency transmission power to meet the requirement. These factors make the signal transmission line the most power-consuming part in the communication system.

The communication apparatus 100 of the present invention first performs signal switching and merging on the small signals (i.e., the first analog signal AU1 and the second analog signal AU2) generated by the first signal transceiver circuit 150A and the second signal transceiver circuit 150B by using the switch 140 and the signal co-processing circuit 110 and subsequently performs signal amplifying on the merged the transmission signal TS by using the first signal amplifying circuit 120A during the signal transmission. The implementation complexity of the circuits for switching and merging of different signals is thus lowered.

Even if the switching and merging of the signals still face the loss, under the condition that the same ratio of loss exists, the amount of the direct current consumption wasted during the transmission of the large signal and the amount of the direct current consumption wasted during the transmission of the small signal are of totally different orders.

For example, when 30% of the transmission power loss exists for each of a signal of 1 milliwatt (mW) and a signal of 100 milliwatts, the difference between the wasted direct current power dissipation is obvious. As a result, from the point of view regarding to power-saving, a better power-saving result can be obtained by performing switching and merging of the signals before the signals are amplified by the power amplifier.

Further, the process of dividing the signal into several parts (e.g., two parts in the embodiment in FIG. 1) to be merged at the small signal level and transmitted to the power amplifier subsequently does not increase the overall power dissipation of the transceiver circuit to a great degree. The conversion circuit 160 serving as an analog front-end circuit and the base band circuit 170 that is a digital circuit may operate according to a clock signal having a lower frequency such that the complexity of the digital circuit is further lowered. Since the relation among the complexity, the required chip area and the bandwidth of the operation frequency of the communication circuit is not necessarily linear and is possibly exponential, the power dissipation that is saved by using the communication apparatus 100 of the present invention allows the designer to have more design flexibility regarding to the chip power dissipation ratio.

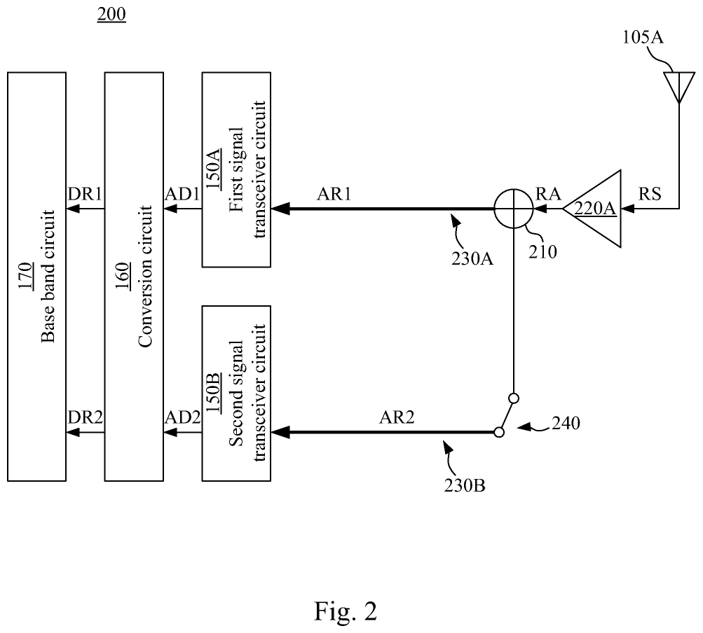

Reference is now made to FIG. 2. FIG. 2 illustrates a block diagram of a communication apparatus 200 according to an embodiment of the present invention. The communication apparatus 200 includes the first antenna 105A, a signal co-processing circuit 210, a first signal amplifying circuit 220A, a first signal path 230A, a second signal path 230B, a switch 240, the first signal transceiver circuit 150A, the second signal transceiver circuit 150B, the conversion circuit 160 and the base band circuit 170.

The connection relation of the components in the communication apparatus 200 is first described in the following paragraphs.

The first signal amplifying circuit 220A is electrically coupled between the first antenna 105A and the signal co-processing circuit 210. In the present embodiment, the first signal amplifying circuit 220A is a low noise amplifier (LNA), and the signal co-processing circuit 210 is a power splitter.

In the present embodiment, the first signal path 230A is a first signal receiving path and is electrically coupled to the signal co-processing circuit 210. In an embodiment, the first signal path 230A may not include any circuit component or may include at least one circuit component that does not affect the function of the communication apparatus 200. The present invention is not limited thereto.

In the present embodiment, the second signal path 230B is a second signal receiving path. In an embodiment, the second signal path 230B may not include any circuit component or may include at least one circuit component that does not affect the function of the communication apparatus 200. The present invention is not limited thereto.

The switch 240 is configured to operate in either a merged communication state or a non-merged communication state. In the present embodiment, the switch 240 electrically couples the second signal path 230B and the signal co-processing circuit 210 under the merged communication state. The switch 240 makes the second signal path 230B floating under the non-merged communication state.

The first signal transceiver circuit 150A is configured to perform communication in a first frequency band with another communication apparatus (not illustrated in the figure) through the first signal path 230A, the signal co-processing circuit 210, the first signal amplifying circuit 220A and the first antenna 105A. In the present embodiment, the first signal transceiver circuit 150A performs signal receiving by using a receiving circuit (RX, not illustrated in the figure) therein through the components described above.

The second signal transceiver circuit 150B, under the merged communication state, is configured to perform communication in a second frequency band with another communication apparatus (not illustrated in the figure) through the second signal path 230B, the switch 240, the signal co-processing circuit 210, the first signal amplifying circuit 220A and the first antenna 105A. In the present embodiment, the second signal transceiver circuit 150B performs signal receiving by using a receiving circuit (not illustrated in the figure) therein through the components described above.

The base band circuit 170 is electrically coupled to the first signal transceiver circuit 150A and the second signal transceiver circuit 150B through the conversion circuit 160.

The operation of the components in the communication apparatus 200 is subsequently described in the following paragraphs.

In operation, the first antenna 105A receives a received signal RS, and the received signal RS is amplified by the first signal amplifying circuit 220A to generate a received signal RA. The received signal RA that is amplified is further split into a first analog signal AR1 corresponding to the first frequency band and a second analog signal AR2 corresponding to the second frequency band by the signal co-processing circuit 210 implemented by a power splitter. Since the first analog signal AR1 belongs to the first frequency band and the second analog signal AR2 belongs to the second frequency band, the first analog signal AR1 and the second analog signal AR2 do not interfere with each other in the merged received signal RA. In an embodiment, each of the first frequency band and the second frequency band has a bandwidth of 80 MHz. The first frequency band and the second frequency band together form an equivalent bandwidth of 160 MHz.

The first signal transceiver circuit 150A receives the first analog signal AR1 through the first signal path 230A, is configured to perform frequency down-conversion or other signal processing on the first analog signal AR1 to generate a first analog signal AD1 and transmits the first analog signal AD1 that is processed to the conversion circuit 160.

The second signal transceiver circuit 150B receives the second analog signal AR2 through the second signal path 230B, is configured to perform frequency down-conversion or other signal processing on the second analog signal AR2 to generate a second analog signal AD2 and transmits the second analog signal AD2 that is processed to the conversion circuit 160.

In an embodiment, both of the first signal transceiver circuit 150A and the second signal transceiver circuit 150B do not perform any power amplifying on the first analog signal AR1 and the second analog signal AR2.

After the conversion circuit 160 receives the first analog signal AD1 to perform analog-to-digital conversion thereon to generate a first digital signal DR1, the base band circuit 170 receives the first digital signal DR1 from the conversion circuit 160. After the conversion circuit 160 receives the second analog signal AD2 to perform analog-to-digital conversion thereon to generate a second digital signal DR2, the base band circuit 170 receives the second digital signal DR2 from the conversion circuit 160.

In an embodiment, the conversion circuit 160 described above may perform analog-to-digital conversion by using an analog-to-digital conversion circuit (not illustrated in the figure) therein.

In an embodiment, since the switch 240 makes the second signal path 230B floating under the non-merged communication state, the second signal transceiver circuit 150B does not perform communication when the switch 240 operates under the non-merged communication state.

In some approaches, each of different signal transceiver circuits is equipped with a unique low noise amplifier circuit to perform signal amplifying after the splitting of the received signal is performed. The power combiner and the radio frequency switch cause additional power loss and reduce the lowest sensitivity of the receiving circuit.

The communication apparatus 200 of the present invention performs signal receiving by allowing the signal being received by the first antenna 105A to be directly transmitted to the first signal amplifying circuit 220A that is the low noise amplifier to avoid the influence on the noise figure (NF) of the receiving path caused by the external switch and the power combiner. When only one low noise amplifier is used, the loss of the individual lowest sensitivity of the receiving circuit regarding to each the signals in two different frequency bands is theoretically avoided. The trade-off between sharing of the antenna and the lowest sensitivity in the receiving system can be avoided, and the power dissipation of the low noise amplifier can be saved.

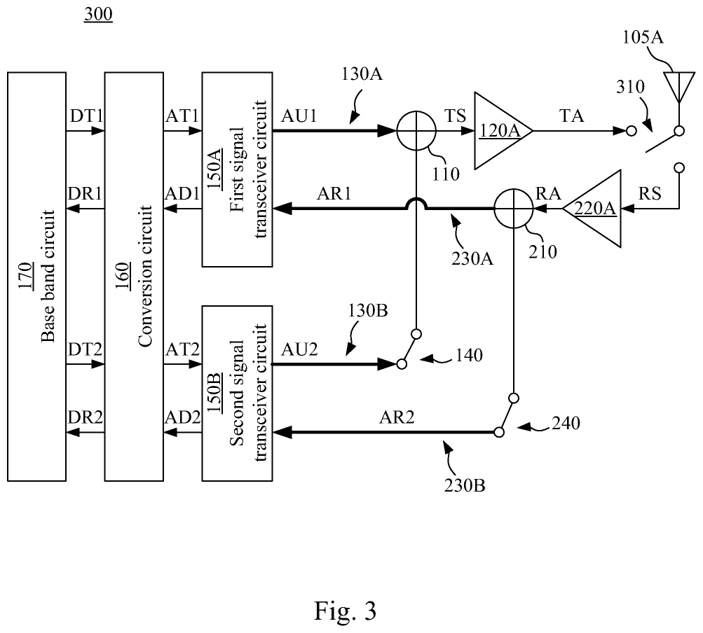

FIG. 3 illustrates a block diagram of a communication apparatus 300 according to an embodiment of the present invention.

The components in the communication apparatus 300 is a union of the components of the communication apparatus 100 in FIG. 1 and the components of the communication apparatus 200 in FIG. 2, which include the first antenna 105A, the signal co-processing circuit 110, the signal co-processing circuit 210, the first signal amplifying circuit 120A, the first signal amplifying circuit 220A, the first signal path 130A, the first signal path 230A, the second signal path 130B, the second signal path 230B, the switch 140, the switch 240, the first signal transceiver circuit 150A, the second signal transceiver circuit 150B, the conversion circuit 160 and the base band circuit 170.

The connection relation of the components described above is the same as the connection relation illustrated in the communication apparatus 100 in FIG. 1 and the connection relation illustrated in the communication apparatus 200 in FIG. 2. The communication apparatus 300 performs signal transmission and signal receiving by using the operation of the communication apparatus 100 in FIG. 1 and the operation of the communication apparatus 200 in FIG. 2 described above.

In the present embodiment, the communication apparatus 300 further includes a transceiver switch 310 disposed between the first signal amplifying circuit 120A, the first antenna 105A and the first signal amplifying circuit 220A.

The transceiver switch 310 electrically couples the first signal amplifying circuit 120A and the first antenna 105A under a transmission state. The transceiver switch 310 electrically couples the first signal amplifying circuit 220A and the first antenna 105A under a receiving state. As a result, based on the operation of transceiver switch 310, the communication apparatus 300 performs signal transmission and signal receiving by using the single first antenna 105A.

In different embodiments, the first signal amplifying circuit 120A and the first signal amplifying circuit 220A may not be coupled to the antenna through the transceiver switch 310 and may be coupled to the antenna by using different configurations depending on the practical requirements. Possible connection methods are described in the following two embodiments.

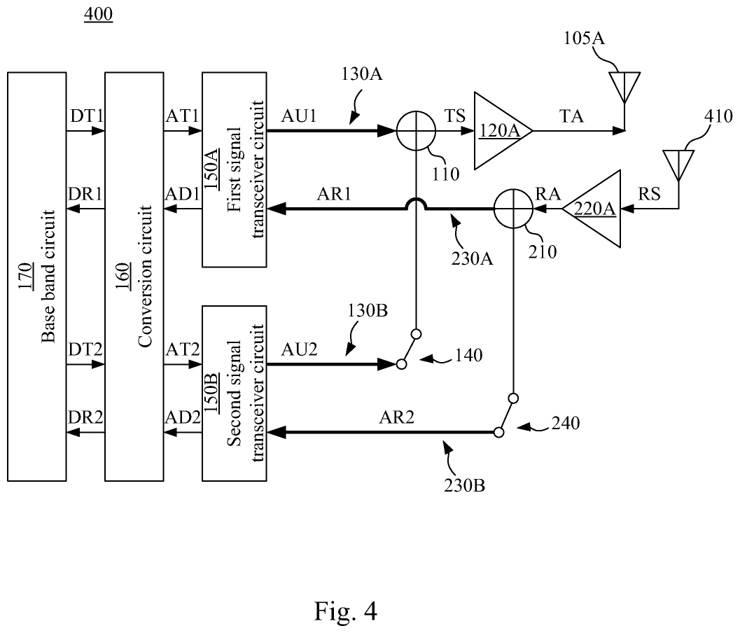

Reference is now made to FIG. 4. FIG. 4 illustrates a block diagram of a communication apparatus 400 according to an embodiment of the present invention. The components included in the communication apparatus 400 are mostly identical to those in the communication apparatus 300. As a result, the configuration and the operation of the identical components are not described herein. The difference between the communication apparatus 300 and the communication apparatus 400 is that the communication apparatus 400 does not include the transceiver switch 310. On the other hand, the communication apparatus 400 further includes a first antenna 410.

The first signal amplifying circuit 120A is directly electrically coupled to the first antenna 105A. The first antenna 105A only allows the first signal amplifying circuit 120A to perform signal transmission therethrough. The first signal amplifying circuit 220A is directly electrically coupled to the first antenna 410. The first antenna 410 only allows the first signal amplifying circuit 220A to perform signal receiving therethrough.

By using such a configuration, the first signal amplifying circuit 120A may perform signal transmission through the first antenna 105A and the first signal amplifying circuit 220A may perform signal receiving through the first antenna 410 simultaneously without being restricted by the frequencies of the signals.

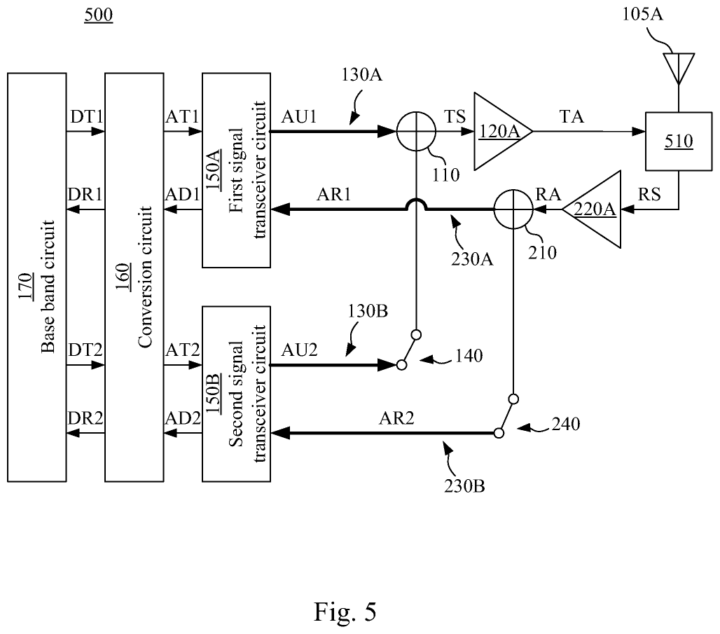

Reference is now made to FIG. 5. FIG. 5 illustrates a block diagram of a communication apparatus 500 according to an embodiment of the present invention.

The components included in the communication apparatus 500 are mostly identical to those in the communication apparatus 300. As a result, the configuration and the operation of the identical components are not described herein. The difference between the communication apparatus 300 and the communication apparatus 500 is that the communication apparatus 500 does not include the transceiver switch 310. Instead, the communication apparatus 500 includes a duplexer 510 that allows bi-directional signal transmission. The duplexer 510 is a type of apparatus operated on the frequency domain and is not the type of apparatus of the transceiver switch, in which the duplexer 510 may be used in the field of Long Term Evolution (LTE) technologies.

The duplexer 510 replaces the transceiver switch 310 to be disposed among the first signal amplifying circuit 120A, the first antenna 105A and the first signal amplifying circuit 220A such that the first signal amplifying circuit 120A and the first signal amplifying circuit 220A may simultaneously perform signal transmission and signal receiving corresponding to different frequencies through the first antenna 105A.

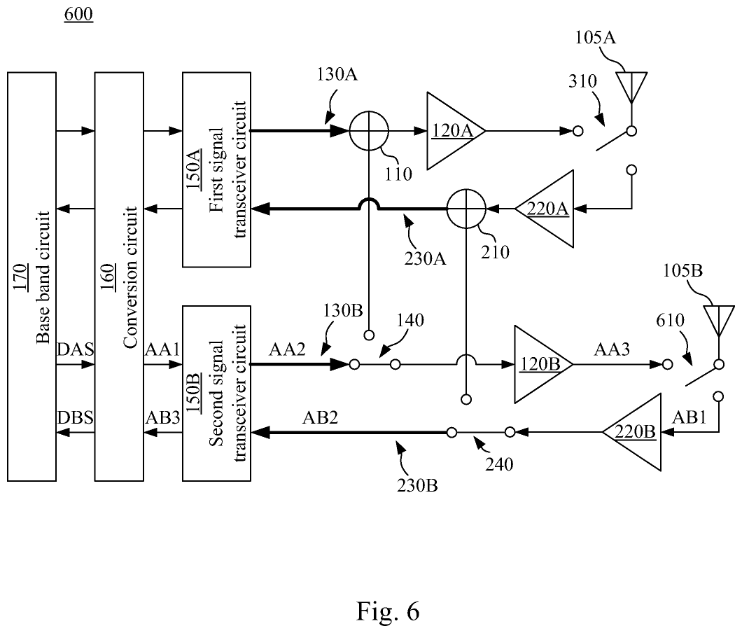

Reference is now made to FIG. 6. FIG. 6 illustrates a block diagram of a communication apparatus 600 according to an embodiment of the present invention. The components included in the communication apparatus 600 are mostly identical to those in the communication apparatus 300. As a result, the configuration and the operation of the identical components are not described herein. The difference between the communication apparatus 300 and the communication apparatus 600 is that the communication apparatus 600 further includes a second antenna 105B, a second signal amplifying circuit 120B, a second signal amplifying circuit 220B and a transceiver switch 610.

Through the operation of the transceiver switch 610, the second signal amplifying circuit 120B and the second signal amplifying circuit 220B can be electrically coupled between the second signal transceiver circuit 150B and the second antenna 105B.

More specifically, the transceiver switch 610 is disposed among the second signal amplifying circuit 120B, the second antenna 105B and the second signal amplifying circuit 220B. The transceiver switch 610 electrically couples the second signal amplifying circuit 120B and the second antenna 105B under the transmission state. The switch 140 electrically couples the second signal path 130B and the second signal amplifying circuit 120B under the non-merged communication state.

By using the operation described above, the second signal transceiver circuit 150B performs communication in the second frequency band through the second signal path 130B, the second signal amplifying circuit 120B and the second antenna 105B under the non-merged communication state.

More specifically, the base band circuit 170 provides a digital signal DAS to the conversion circuit 160 such that the conversion circuit 160 performs conversion to generate an analog signal AA1. The second signal transceiver circuit 150B, after performing frequency up-conversion and other processing on the analog signal AA1 to generate an analog signal AA2, transmits the analog signal AA2 through the second signal path 130B to be amplified by the second signal amplifying circuit 120B to generate an analog signal AA3. The second antenna 105B further transmits the analog signal AA3 that is amplified.

On the other hand, the transceiver switch 610 electrically couples the second signal amplifying circuit 220B and the second antenna 105B under the receiving state. The switch 240 electrically couples the second signal path 230B and the second signal amplifying circuit 220B under the non-merged communication state.

By using the operation described above, the second signal transceiver circuit 150B is configured to perform communication in the second frequency band through the second signal path 230B, the second signal amplifying circuit 220B and the second antenna 105B under the non-merged communication state.

More specifically, the second antenna 105B receives an analog signal AB1 and the second signal amplifying circuit 220B performs signal amplifying thereon to generate a second analog signal AB2. The second signal transceiver circuit 150B receives the second analog signal AB2 through the second signal path 230B to perform frequency down-conversion and other processing thereon to generate a second analog signal AB3. The conversion circuit 160 performs conversion on the second analog signal AB3 to generate a digital signal DBS to be received by the base band circuit 170.

As a result, by using the operation described above, the communication apparatus 600 allows the second signal amplifying circuit 120B and the second signal amplifying circuit 220B to perform signal transmission and signal receiving through the single second antenna 105B under the non-merged communication state.

In an embodiment, the transceiver switch 310 and the transceiver switch 610 of the communication apparatus 600 can be replaced by the configuration in FIG. 4. More specifically, the configuration of the transceiver switch 310 may be replaced by the configuration that the first signal amplifying circuit 120A and the first signal amplifying circuit 220A are directly coupled to different antennas. The configuration of the transceiver switch 610 may be replaced by the configuration that the first signal amplifying circuit 120B and first signal amplifying circuit 220B are directly coupled to different antennas.

In another embodiment, the transceiver switch 310 and the transceiver switch 610 of the communication apparatus 600 can be replaced by the configuration in FIG. 5. More specifically, the transceiver switch 310 can be replaced by a duplexer and the transceiver switch 610 can be replaced by another duplexer.

It is appreciated that the embodiments described above are merely an example. In other embodiments, it is appreciated that many modifications and changes may be made by those of ordinary skill in the art without departing, from the spirit of the invention.

Take FIG. 1 as an example, the first signal transceiver circuit 150A and the first signal path 130A form a first channel, and the second signal transceiver circuit 150B, the switch 140 and the second signal path 130B form a second channel. The number of the second channel can be N and the N second channels can all be electrically coupled to the signal co-processing circuit 110, in which N is an integer being larger than or equal to 1.

Take FIG. 2 as an example, the first signal transceiver circuit 150A and the first signal path 230A form a first channel, and the second signal transceiver circuit 150B, the switch 240 and the second signal path 230B form a second channel. The number of the second channel can be N and the N second channels can all be electrically coupled to the signal co-processing circuit 210, in which N is an integer being larger than or equal to 1.

For FIG. 3, the first signal transceiver circuit 150A, the first signal path 130A and the first signal path 230A form a first channel, and the second signal transceiver circuit 150B, the switch 140, the second signal path 130B, the switch 240 and the second signal path 230B form a second channel. The number of the second channel can be N and the N second channels can all be electrically coupled to the signal co-processing circuit 110 and the signal co-processing circuit 210, in which N is an integer being larger than or equal to 1.

By using the configuration described above, the signals of a multiple of second channels can be processed together with the signal of the first channel to perform signal transmission and/or signal receiving.

In summary, the communication apparatus disposes a signal amplifying circuit in front of an antenna so as to perform signal switching and merging at a small-signal level first and perform signal amplifying subsequently in a signal transmission process to decrease the power loss. Further, the communication apparatus performs signal amplifying first and performs signal switching and splitting subsequently in a signal receiving process such that a lowest sensitivity of the signal receiving is not affected.

The aforementioned descriptions represent merely the preferred embodiments of the present disclosure, without any intention to limit the scope of the present disclosure thereto. Various equivalent changes, alterations, or modifications based on the claims of present disclosure are all consequently viewed as being embraced by the scope of the present disclosure.

What is claimed is:

1. A communication apparatus, comprising:
a first antenna;
a signal co-processing circuit;
a first signal amplifying circuit electrically coupled between the signal co-processing circuit and the first antenna;
a first signal path electrically coupled to the signal co-processing circuit;
a second signal path;
a switch electrically coupling the second signal path to the signal co-processing circuit under a merged communication state;
a first signal transceiver circuit configured to perform communication in a first frequency band through the first signal path, the signal co-processing circuit, the first signal amplifying circuit and the first antenna; and
a second signal transceiver circuit configured to perform communication on a second frequency band through the second signal path, the switch, the signal co-processing circuit, the first signal amplifying circuit and the first antenna under the merged communication state.

2. The communication apparatus of claim 1, wherein the first signal path is a first signal transmission path, the second signal path is a second signal transmission path, the first signal amplifying circuit is a power amplifier and the signal co-processing circuit is a power combiner;
the first signal transceiver circuit performs transmission of a first analog signal corresponding to the first frequency band through the first signal path and the second signal transceiver circuit performs transmission of a second analog signal corresponding to the second frequency band through the second signal path, such that the power combiner merges the first analog signal and the second analog signal to generate a transmission signal to be amplified by the first signal amplifying circuit and further transmitted by the first antenna.

3. The communication apparatus of claim 2, further comprising:
a conversion circuit; and
a base band circuit electrically coupled to the first signal transceiver circuit and the second signal transceiver circuit through the conversion circuit to provide a first digital signal to the conversion circuit to perform digital-to-analog conversion thereon to generate the first analog signal to be transmitted to the first signal transceiver circuit, and provide a second digital signal to the conversion circuit to perform digital-to-analog conversion thereon to generate the second analog signal to be transmitted to the second signal transceiver circuit.

4. The communication apparatus of claim 2, further comprising:
a transceiver switch disposed between the first signal amplifying circuit and the first antenna and configured to electrically couple the first signal amplifying circuit and the first antenna under a transmission state and electrically isolate the first signal amplifying circuit and the first antenna under a receiving state.

5. The communication apparatus of claim 2, wherein the first signal amplifying circuit is directly electrically coupled to the first antenna and the first antenna only allows the first signal amplifying circuit to perform signal transmission therethrough.

6. The communication apparatus of claim 2, further comprising:
a duplexer electrically coupled between the first signal amplifying circuit and the first antenna such that the first antenna simultaneously performs signal transmission and signal receiving corresponding to different frequency bands.

7. The communication apparatus of claim 1, wherein the first signal path is a first signal receiving path, the second signal path is a second signal receiving path, the first signal amplifying circuit is a low noise amplifier (LNA) and the signal co-processing circuit is a power splitter;
the first antenna receives a received signal to be amplified by the first signal amplifying circuit and further split into a first analog signal corresponding to the first frequency band and a second analog signal corresponding to the second frequency band by the power splitter, such that the first signal transceiver circuit performs signal receiving on the first analog signal through the first signal path and the second signal transceiver circuit performs signal receiving on the second analog signal through the second signal path.

8. The communication apparatus of claim 7, further comprising:
a conversion circuit; and
a base band circuit electrically coupled to the first signal transceiver circuit and the second signal transceiver circuit through the conversion circuit to receive a first digital signal after the conversion circuit receives and performs analog-to-digital conversion on the first analog signal to generate the first digital signal, and receive a second digital signal after the conversion circuit receives and performs analog-to-digital conversion on the second analog signal to generate the second digital signal.

9. The communication apparatus of claim 7, further comprising:
a transceiver switch disposed between the first signal amplifying circuit and the first antenna and configured to electrically couple the first signal amplifying circuit and the first antenna under a receiving state.

10. The communication apparatus of claim 7, wherein the first signal amplifying circuit is directly electrically coupled to the first antenna and the first antenna only allows the first signal amplifying circuit to perform signal receiving therethrough.

11. The communication apparatus of claim 7, further comprising:
a duplexer electrically coupled between the first signal amplifying circuit and the first antenna such that the first antenna simultaneously performs signal transmission and signal receiving corresponding to different frequency bands.

12. The communication apparatus of claim 1, further comprising:
a second antenna; and
a second signal amplifying circuit electrically coupled between the second signal transceiver circuit and the second antenna;
wherein the switch electrically couples the second signal path and the second signal amplifying circuit under a non-merged communication state, and the second signal transceiver circuit is configured to perform communication corresponding to the second frequency band through the second signal path, the second signal amplifying circuit and the second antenna under the non-merged communication state.

13. The communication apparatus of claim 1, wherein the switch makes the second signal path floating under a non-merged communication state such that the second signal transceiver circuit does not perform communication.

14. The communication apparatus of claim 1, wherein the first signal path and the first signal transceiver circuit form a first channel, and the second signal path, the switch and the second signal transceiver circuit form a second channel, in which a number of the second channel is N, N being an integer larger than or equal to 1.
